(19) United States
(12) Patent Application Publication
(10) Pub. No.: US 2013/0146555 A1
(43) Pub. Date: Jun. 13, 2013

(54) BASE SUPPORT FOR HOISTING APPARATUS

(71) Applicants: Martin Dufour, Shefford (CA); Michael Parker, Ste-Julie (CA); Denis Poissant, Les Coteaux (CA)

(72) Inventors: Martin Dufour, Shefford (CA); Michael Parker, Ste-Julie (CA); Denis Poissant, Les Coteaux (CA)

(73) Assignee: 9105-0732 QUEBEC INC., Les Coteaux, QC (CA)

(21) Appl. No.: 13/817,517

(22) PCT Filed: Aug. 17, 2011
(86) PCT No.: PCT/CA2011/000954

§ 371 Date: Feb. 18, 2013

Related U.S. Application Data
(60) Provisional application No. 61/374,394, filed on Aug. 17, 2010.

(51) Int. Cl. B66C 5/00; B66C 23/26

(52) U.S. Cl. CPC B66C 5/00; B66C 23/26
USPC 212/179; 248/674

(57) ABSTRACT

A base support for mounting a hoisting apparatus over an opening. The base support comprises a plurality of elongated framing members coupled to each other in a closed polygonal arrangement sized and shaped to surround the opening. The polygonal arrangement has a plurality of corners where two of the framing members meet. The base support also comprises a hoisting apparatus bracket securable to at least one of the framing members and having a hoisting apparatus mounting assembly for mounting the hoisting apparatus thereto.

### FIELD OF THE INVENTION

The present invention relates to structures for supporting hoisting apparatuses and the like. More particularly, the present invention relates to a base support for a hoisting apparatus.

### BACKGROUND OF THE INVENTION

Hoisting apparatuses, such as jib cranes, hoists, lifts and the like, can be temporarily mounted around manholes which provide access to confined spaces or underground structures such as sewers, boilers and drains. Hoisting apparatuses may also be temporarily mounted at construction sites, for example on a partially completed building in order to move supplies between floors. After use, such hoisting apparatuses are typically dismounted, disassembled, or otherwise removed.

Various structures are known for supporting hoisting apparatuses. For example, U.S. Pat. No. 7,213,715, issued to the applicant, discloses a hoisting apparatus mounted to a security barrier which can be positioned around a manhole or opening.

Other structures include tripods comprising three legs which meet at a point above a manhole or opening, and a lift, winch or the like to be fixed at that meeting point. Examples of such tripod hoists are described in the following US patents: U.S. Pat. No. 4,589,523; U.S. Pat. No. 4,660,679 and U.S. Pat. No. 4,824,076.

Also known in the art are structures which have three legs extending outwardly at the base of a vertical mast. The mast can be positioned such that two of the three legs straddle the manhole or opening while the third extends away therefrom. Similar supports, such as the one described in U.S. Pat. No. 4,838,439, are also known which comprise outwardly extending legs arranged in an H-shape at the base of a vertical mast.

It is further known to bolt the base of a hoisting apparatus to the ground or another surface, and to provide support structures which mount a hoisting apparatus to the trailer hitch of a vehicle.

However, various drawbacks are also associated with such conventional structures for supporting hoisting apparatuses. For example, conventional structures are not usually designed to be easily combined with security barriers which are installed around a manhole to prevent worker from inadvertently falling into it. Thus, security barriers need to be installed independently from conventional structures. In addition, conventional structures are typically designed to mount around specific openings, such as manholes, or onto specific features or surfaces, and are therefore limited in their application.

Hence, in light of the aforementioned, there is a need for an improved base support which, by virtue of its design and components, would be able to overcome some of the above-discussed prior art problems. In particular, there is a need for a base support which can be combined with a security barrier and/or can be more versatile and adaptable to a variety of situations, when need be.

### SUMMARY OF THE INVENTION

An object of the present invention is to provide an improved base support that satisfies at least one of the above-mentioned needs.

In accordance with one aspect of the invention, there is provided a base support for mounting a hoisting apparatus over an opening. The base support comprises a plurality of elongated framing members coupled to each other in a closed polygonal arrangement sized and shaped to surround the opening. The polygonal arrangement has a plurality of corners where two of the framing members meet. The base support also comprises a hoisting apparatus bracket securable to at least one of the framing members and having a hoisting apparatus mounting assembly for mounting the hoisting apparatus thereto.

Preferably, each of the framing members of the base support is provided with a plurality of apertures extending transversally therein.

Still preferably, the hoisting apparatus bracket of the base support comprises at least one bracket sleeve member adapted to engage one of the framing member. Each bracket sleeve member has first and second parallel side walls adapted to extend on either sides of the corresponding framing member and at least one bracket locking mechanism. Each bracket locking mechanism is associated with one of the bracket sleeve members for securing the one of the bracket sleeve members to the corresponding framing member.

Still preferably, each bracket locking mechanism comprises at least one pair of apertures extending in transversal alignment through the first and second side walls of the corresponding bracket sleeve member, at least one bracket locking pin and at least one pin securing device. Each bracket locking pin is associated with a corresponding pair of apertures in the bracket sleeve member and is insertable in the aperture in the first wall, one of the apertures of the corresponding framing member and the aperture in the second wall, successively. Each pin securing device is associated with a corresponding one of the bracket locking pin for securing the same in position through said apertures.

Still preferably, the base support further comprises a plurality of couplers where each of the couplers is associated with a respective one of the corners for coupling the two of the framing members meeting thereat. The couplers are securable to the framing members using a similar assembly to that described in connection with the hoisting apparatus bracket.

Alternatively, each of the two of the framing members meeting in a respective one of the corners can be permanently joined to each other thereat.

Still preferably, a security barrier can be used in combination with the base support, the security barrier being removably securable to the base support. The security barrier is securable to the framing members using a similar assembly to that described in connection with the hoisting apparatus bracket.

Preferably, the base support is formed of four framing members positioned at right angles, so as to form a rectangular shape.

In accordance with another aspect of the invention, there is also provided a hoisting assembly comprising a mast, a jib crane mounted to the mast and extending over an opening, and a base support. The base support comprises a plurality of elongated framing members coupled to each other in a closed polygonal arrangement sized and shaped to surround the opening. The polygonal arrangement has a plurality of corners where two of the framing members meet. The base support also comprises a bracket securable to at least one of the framing members and having a mast mounting assembly for mounting the mast thereto.

As can be appreciated, the closed polygonal arrangement of the base support structure surrounding the opening, in accordance with the present invention, provides increased stability to the base support. Moreover, the base support according to the present invention can be easily combined with a security barrier to offer an anchor point, and when the framing members are coupled using the plurality of couplers, the base support can be adapted to a wide variety of circumstances and environments.

### BRIEF DESCRIPTION OF THE DRAWINGS

The invention will be better understood upon a reading of the following non-restrictive description of the preferred embodiment, made with reference to the following drawings.

FIGS. 1 and 2 are a top view and perspective view, respectively, of a base support in accordance with an embodiment of the present invention, which has been mounted above an opening and to which a hoisting apparatus and a security barrier is attached

FIG. 3 is a side view of the base support of FIGS. 1 and 2.

FIGS. 4 and 5 are a side view and top view, respectively, of a base support in accordance with another embodiment of the present invention, which has been mounted above an opening and to which a hoisting apparatus is attached.

FIGS. 6 to 8 are a perspective, top and side view, respectively, of the base support of FIGS. 4 and 5.

While the invention will be described in conjunction with example embodiments, it will be understood that it is not intended to limit the scope of the invention to these embodiments. On the contrary, it is intended to cover all alternatives, modifications and equivalents as apparent to one of ordinary skill in the art.

### DETAILED DESCRIPTION OF THE PREFERRED EMBODIMENT OF THE INVENTION

In the following description, the same numerical references refer to similar elements. The embodiments shown in the figures are preferred embodiments, for exemplification purposes only.

In the context of the present description, the expression “structure” should be understood to include all types of systems, devices, assemblies, apparatuses or constructions, as apparent to a person skilled in the art. Moreover, it will be appreciated that positional descriptions such as “above”, “below”, “left”, “right” and the like should, unless otherwise indicated, be taken in the context of the figures and should not be considered limiting.

In addition, although the preferred embodiment of the present invention as illustrated in the accompanying drawings comprises various components and although the preferred embodiment of the support structure and corresponding parts of the present invention as shown consist of certain geometrical configurations as explained and illustrated herein, not all of these components and geometries are essential to the invention and thus should not be taken in their restrictive sense, i.e. they should not be taken to limit the scope of the present invention. It is to be understood, as also apparent to a person skilled in the art, that other suitable components and cooperations therebetween, as well as other suitable geometrical configurations, may be used, as will be briefly explained herein and as can be easily inferred herefrom by a person skilled in the art, without departing from the scope of the invention.

It will be appreciated that the present invention may be practiced without the specific details which have been set forth herein below in order to provide a thorough understanding of the invention.

In accordance with a first aspect of the invention, there is provided a base support for mounting a hoisting apparatus over an opening. It will be readily understood by one skilled in the art that the opening can be embodied by any space in the ground, a floor or other surface and through which a hoisting apparatus may be lowered. In one embodiment of the invention the opening is a manhole, but of course the invention is not limited to this particular application. For example, the opening can be a tank, a reservoir, a vault or other types of confined spaces, as well as other types of opening commonly encountered in the construction industry.

Moreover, the term hoisting apparatus is used herein to designate any device which can be used to lift, lower or support either goods or persons through the opening. In some embodiments, the hoisting apparatus may be adapted and/or used for lifting or lowering a load. The hoisting apparatus can also be part of a personal fall arrest systems designed to safely arrest a worker's fall.

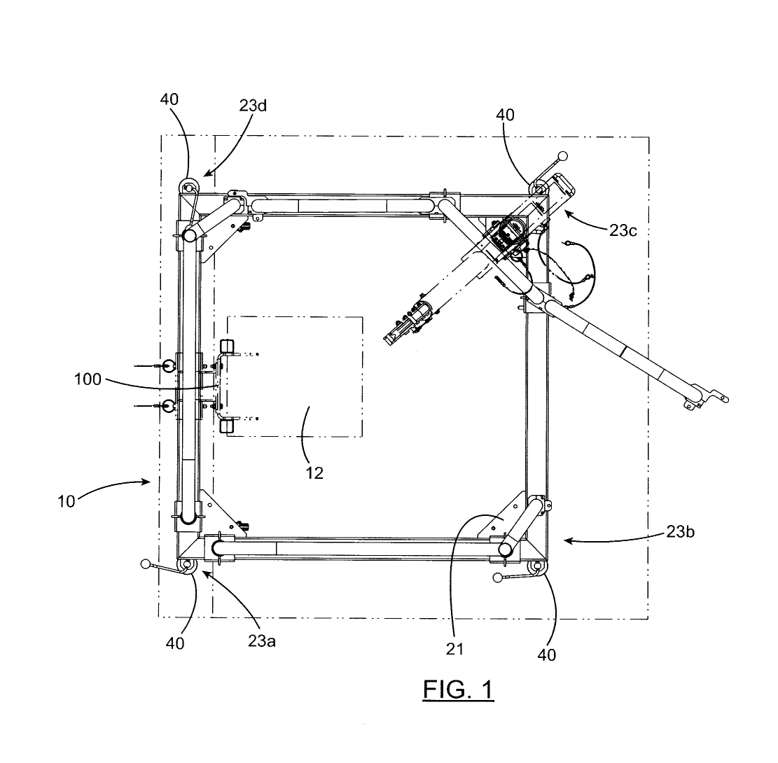

Referring to FIGS. 1 to 3, a base support 10, according to an embodiment of the invention, is shown mounted around an opening 12. A hoisting apparatus 14 including a mast 16 and a jib crane 18 is attached to the base support 10 above and/or beside the opening 12. The jib crane 18 extends over the opening 12 so as to enable the raising and lowering of a person, equipment or other materials. The hoisting apparatus 14 may be operated by a winch or other suitable actuator, as is known in the art, and will not be discussed in further detail herein. Of course, other types or configurations of hoisting apparatus are known in the art and could similarly be used.

The base support 10 includes a plurality of elongated framing members 20a to 20d which are connected so as to form a polygonal arrangement for supporting the hoisting apparatus 14 during use. The polygonal arrangement is sized and shaped to surround the opening and can be configured so as to either match closely the shape of the opening or, on the contrary, leave a large parameter between the outline of the opening 12 and the framing members 20a to 20d. The polygonal arrangement defines a plurality of corners 23a to 23d where two adjacent framing members 20a to 20d meet. Preferably, the framing members 20a to 20d are made from square tube stock, such as extruded aluminum 6061-T6. Alternatively, tube stock of another type, or indeed lengths of solid round or square stock could be used.

As shown in the illustrated embodiment, the four framing members 20a to 20d are preferably of equal length and are arranged in a square shape. However, it will be appreciated that, in another embodiment, those four framing members 20a to 20d could be arranged so as to form another polygonal shape, such as a parallelogram or a trapezoid. In addition, it will be appreciated that framing members of varying lengths could be provided. Similarly, more or less framing members could be provided so as to form diverse polygonal arrangements such as a triangle, a pentagon, a hexagon and so on.

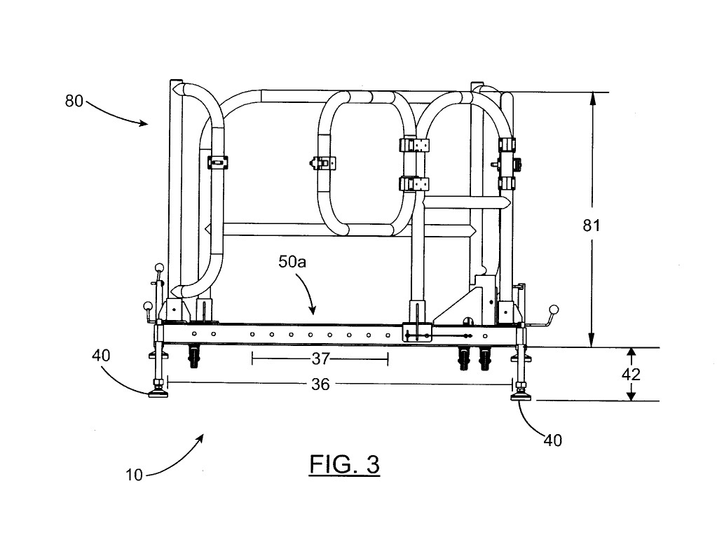

Preferably, each framing member 20a to 20d is provided with a plurality of apertures 50 which extend transversely therein. The apertures 50 can be distributed evenly along the entire length 36 of each framing member 20a to 20d (as shown in FIG. 8) or be evenly distributed only along a middle section 37 of each framing member 20a to 20d (as better shown in FIG. 3). In the latter case other sets of apertures can also be provided towards each extremity of each framing member 20a to 20d, outside of the middle section 37. Alternatively, apertures can be provided only at positions where they are required to affix a component to the framing members, as will be explained below.

In the embodiment presented in FIGS. 1 to 3, the framing members 20a to 20d are permanently joined to one another in the respective corners, thereby resulting in a base support of fixed dimensions and polygonal arrangement. In this embodiment, joining techniques such as bolting, welding, soldering or the like could be used to join two framing members to one another, in a respective corner. Each corner can also be reinforced with webs 21 or other reinforcing structures. The permanent joining of the framing members 20a to 20d result in a base support 10 with a low production cost which can be suitable for workers who often have to use a hoisting apparatus 14 in connection with openings 12 of the same dimension.

Some workers may require a more versatile base support 10, because they use hoisting apparatuses 14 in connection with several different types of openings 12.

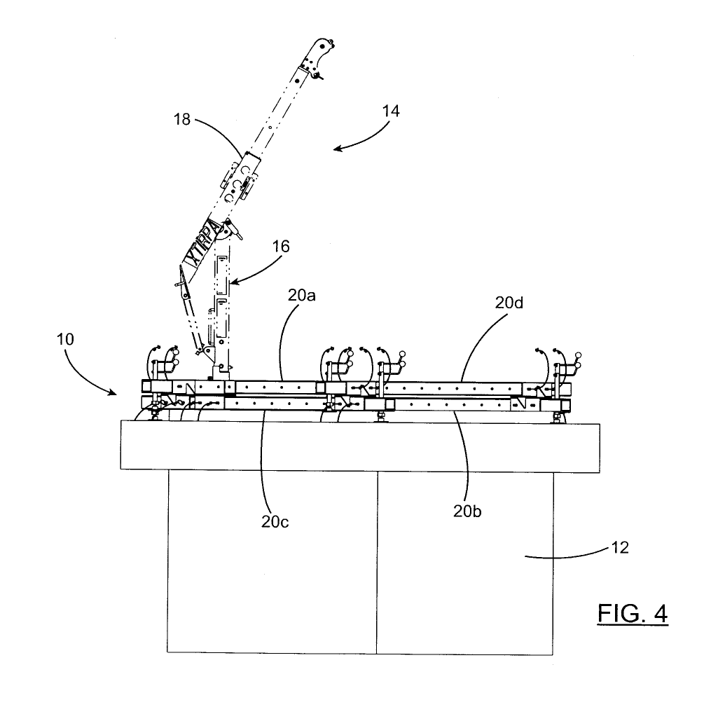

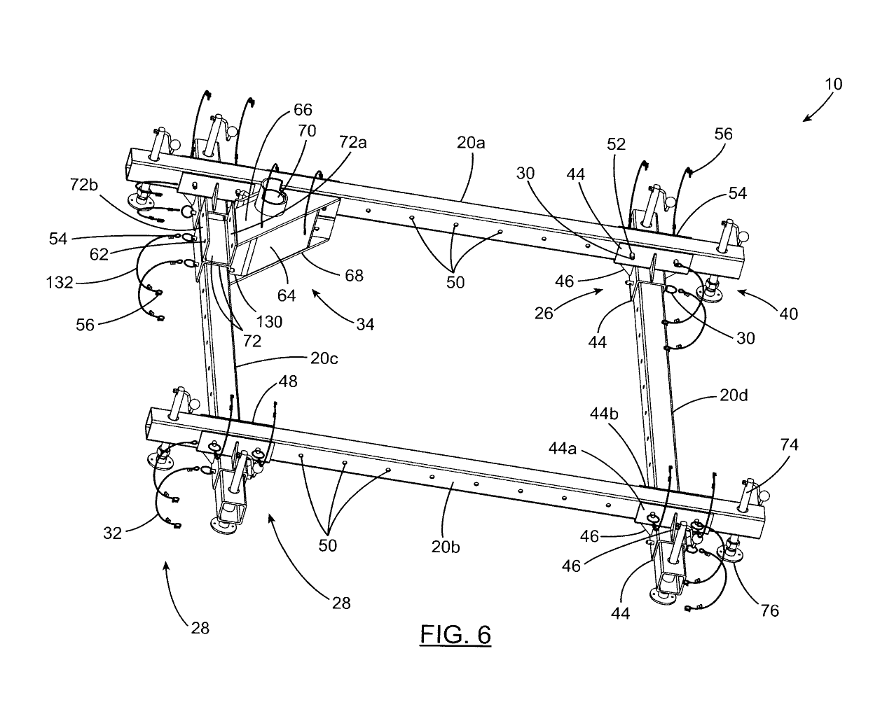

Therefore, another more versatile embodiment is presented in FIGS. 4 to 8. In this embodiment, and as better shown in FIGS. 6 to 8, the base support 10 further includes a plurality of couplers 26, each associated with a respective one of the corners 23a to 23d, for coupling the corresponding two framing members thereat.

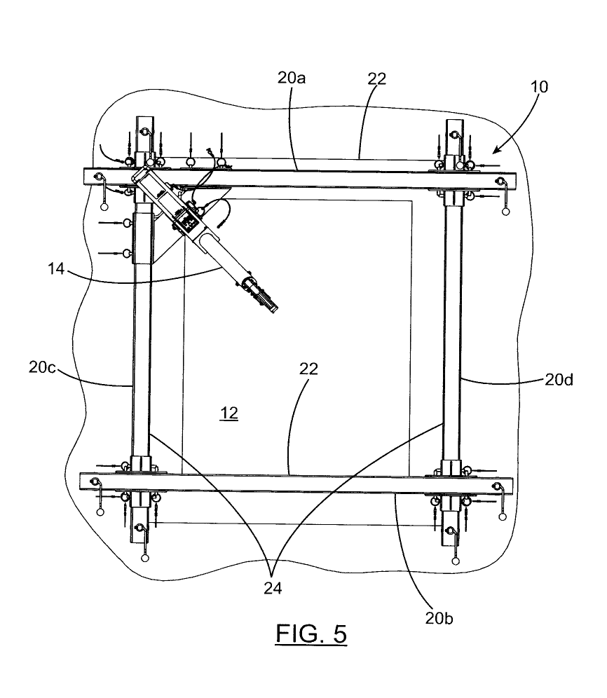

As better shown in FIG. 5. in the illustrated embodiment the framing members 20a and 20b form a first pair 22 which are oriented substantially parallel to one another. Similarly, the framing members 20c and 20d form a second pair 24 which are also oriented substantially in parallel. The first and second pairs 22 and 24 extend perpendicularly to one another and are coupled in an overlapping arrangement, i.e. the first pair 22 sits above the second pair 24. However, it will be appreciated that various other embodiments of the framing members 20a to 20d and couplers 26 are possible. For example, in an alternative embodiment, a first pair of framing members may pass through a second pair of framing members.

Referring to FIG. 6, preferably, the couplers 26 are each made of two sections of U-shaped stock, such as extruded aluminum 6061-T6, welded back-to-back and reinforced with webs 46. Each welded section forms a coupler sleeve member 44, comprising first and second parallel side walls 44a and 44b which are configured to receive one of the framing members 20a to 20d therebetween. However, it will be appreciated that the side walls need not be exactly parallel and could have a slight angle and that differently shaped coupler sleeve members 44 could similarly be used to receive and orient the framing members 20a to 20d, such as sections of L-shaped stock.

In the illustrated embodiment, the coupler sleeve members 44 are welded at right angles to one another. This results in the square shape formed by the framing members 20a to 20d, as shown. In order to form different shapes, the coupler sleeve members 44 could be joined in another non-parallel orientation, in order to form a parallelogram or trapezoidal shape, or in order to accommodate more or less framing members.

In one embodiment, the ends of each framing member 20a and 20d can be coupled to the corresponding couplers 26 at various positions along their length. As such, the top-left and bottom-left couplers 26 associated with the left framing member 20c may, for example, be attached farther along the framing members 20a and 20b, thereby bringing the framing member 20c closer to the parallel framing member 20d. In this way, the shape of the polygonal arrangement can be adjusted in accordance with either the opening 12 around which it is to be used, or to accommodate other constraints and/or obstacles around that opening 12.

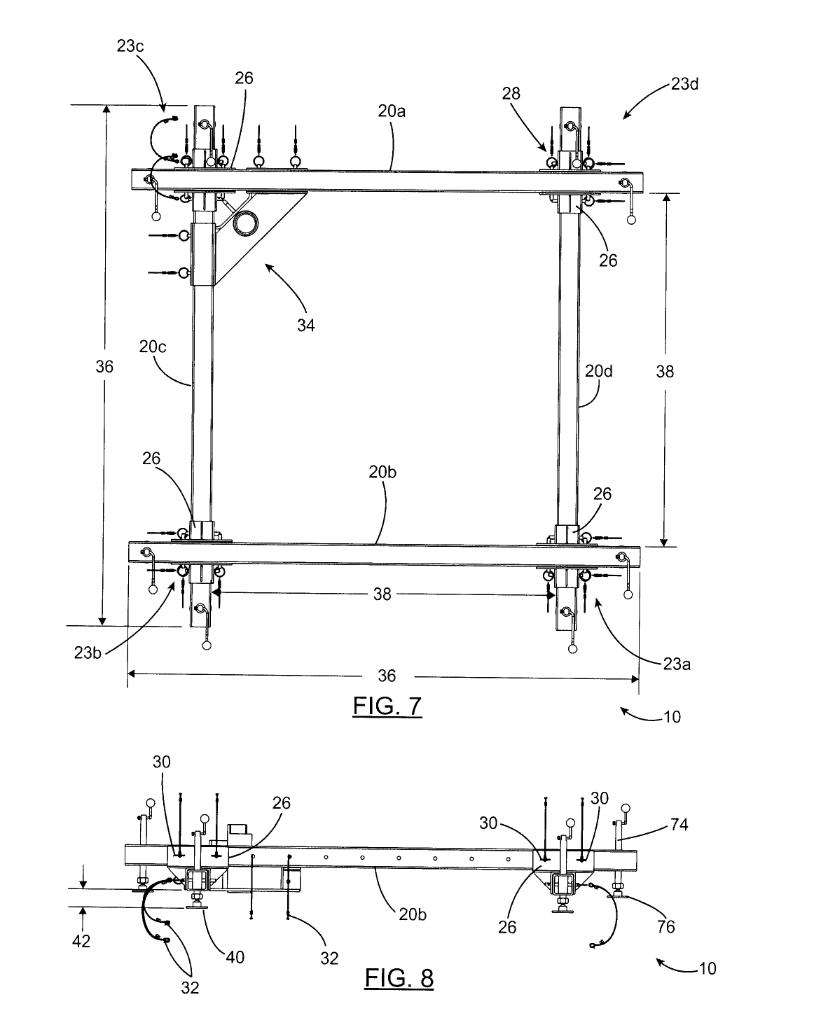

With specific reference to FIG. 7, each framing member 20a to 20d has a length 36. Once positioned and oriented by the couplers 26, the framing members 20a to 20d of each parallel pair 22 and 24 are fixed at a distance 38 from one another. As mentioned above, these two distances 38 are variable and need not be equal for each pair 22 and 24. For an application such as a manhole, the length 36 can for example be approximately 2.13 meters (or seven feet) and the distance 38 preferably varies between a maximum of 1.44 meters (or approximately 56.8 inches) and a minimum of 0.52 meters (or approximately 20.5 inches).

Preferably, the framing members 20a to 20d are free to slide within their respective coupler sleeve member 44 until a polygonal arrangement of suitable size has been obtained. Each framing member is then locked within its respective coupler sleeve member 44 by one of the plurality of coupler locking mechanisms 28 described below.

Now referring back to FIG. 6, the base support comprises coupler locking mechanism 28, for locking the couplers 26 to the framing members 20a to 20d. As previously mentioned, each framing member 20a to 20d is preferably provided with a plurality of apertures 50 which extend transversely therethrough. Preferably, the side walls 44a and 44b of each coupler sleeve member 44 are provided with one or more pair of transversally aligned apertures 52 which can be aligned with the apertures 50 of the framing members 20a to 20d. As such, the apertures 50 define a plurality of predetermined positions at which the framing members 20a to 20d can be coupled to the couplers 26

In the embodiment illustrated in FIG. 6, twelve apertures 50 extend through each framing member 20a to 20d and two corresponding pair of apertures 52 are provided through the side walls of each coupler sleeve member 44. As shown, the apertures 52 of the couplers 26 are aligned with the two outermost apertures 50 of each framing member 20a to 20d, though the apertures 52 could be aligned with any two adjacent apertures 50. Of course, this configuration is shown by way of example only and is in no way considered limitative to the invention.

Once a given framing member 20a to 20d is situated at the desired position, coupler locking pins 30 are used to secure each framing member 20a to 20d within a given coupler sleeve member 44. To secure the coupler, a coupler locking pins 30 is inserted in the aperture 52 in the first wall, then in one of the apertures 50 of the corresponding framing member, and finally in the aperture 52 in the second wall. It will be easily understood that the inverse path could also be used without departing from the scope of the present invention. Once the pin 30 is inserted in the combination of apertures, the pin 30 can be secured in place using a pin securing device.

In the illustrated preferred embodiment, the pin securing device is a cable 32 which has two ends 54 and 56 attachable to respective extremities of the corresponding pin 30. It will be noted that the second end 56 of each cable 32 is shown detached in the figures. The pin 30 is sized and shaped such that once it has been pushed through a given set of aligned apertures 50 and 52, it will extend out the other side. Once the pin 30 is in this locking position, the second end 56 of the cable 32 is attached at the free extremity of the pin 30. The second end 56 can be fixed to the pin 30 using various methods and devices, such as snaps, clips, rivets, bolts and the like. It will also be appreciated that various alternative ways of retaining a locking pin are known in the art. For example, a combination of a bent extremity, or other retaining arrangement, and a locking pin running through a transversal aperture at the other extremity of the pin could be used.

In the illustrated embodiment, each coupler 26 includes two pin 30 and cable 32 combinations for securing each framing member 20a to 20d within its coupler sleeve member 44. The pins 30 may for example be made of zinc plated steel, stainless steel or any other appropriate material. It will also be appreciated that various other systems could be used to lock a framing member 20a to 20d within its coupler sleeve member 44. For example, a cam latch assembly, a nut and bolt assembly, or the like could be used to lock a framing member 20a to 20d within its coupler sleeve member 44, without departing from the scope of the present invention.

The framing members 20a to 20d of the illustrated embodiment can be arranged and locked not just in the square shape shown, but in a wide range of other square and rectangular shapes by locking the couplers 26 at different positions along each framing member 20a to 20d.

Once fully assembled and adjusted, the base support 10 may be dismantled and stored conveniently, although it will be appreciated that it may also be installed permanently.

A single set of framing members 20a to 20d and corresponding components could be adapted to various constraints, although it will be appreciated that a kit could be provided with a number of differently sized framing members, to be selected in accordance with each use.

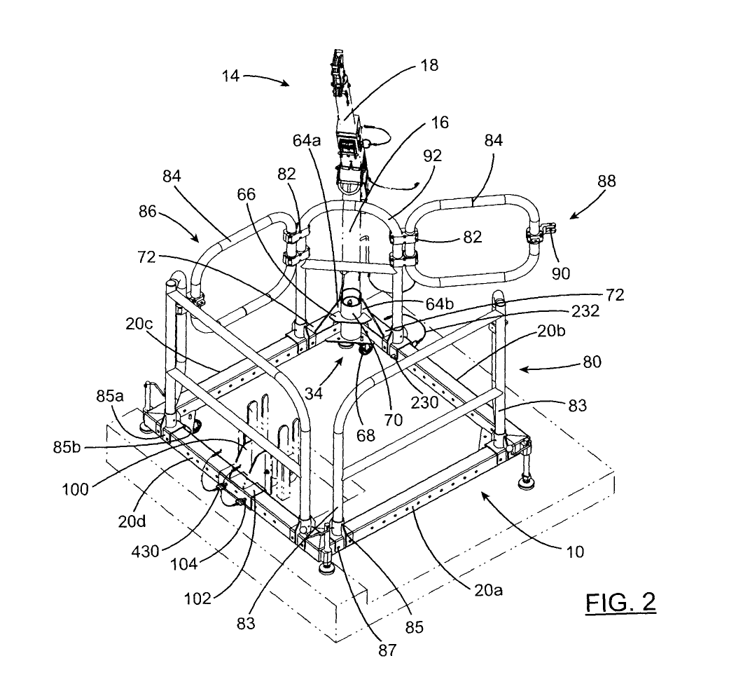

The base support 10 further includes a hoisting apparatus bracket 34 to which a hoisting apparatus, such as that shown in FIGS. 1 and 2, can be mounted. The hoisting apparatus bracket 34, referred hereinafter as the bracket 34, for simplicity, is preferably provided at one of the corners.

Preferably, the bracket 34 comprises corner walls 64a and 64b between which are located a top plate 66 and a bottom plate 68. Alternatively, a face plate 64 can also be provided to form a box shape. These can be bolted, welded or otherwise joined to one another. A hoisting apparatus mounting assembly in the form of a mast sleeve 70 extends upwards from the bottom plate 68 through the top plate 66 and is able to receive or otherwise connect with the mast 16 of a hoisting apparatus 14, as shown in FIG. 2. Preferably, the bracket is made from a sheet of aluminum. It will be appreciated that various constructions could be used to provide a mounting point for the mast 16. For example, in alternative embodiments, the bracket 34 may be constructed to be attached at a suitable point along one of the framing members instead of being provided at a corner of the polygonal arrangement formed by the framing members 20a to 20d.

Preferably, as illustrated in FIG. 6, the bracket preferably includes several sections of U-shaped stock which form bracket sleeve members 72 for receiving the adjacent framing members 20a to 20d therein. Similarly to the couplers 26, the bracket sleeve members 72 each preferably comprise first and second parallel side walls 72a and 72b which are configured to receive one of the framing members 20a to 20d therebetween. The first and second parallel side walls 72a and 72b are provided with two pairs of apertures 62 which can be aligned with two of the apertures 50 along each framing member 20a to 20d. Two bracket locking pins 130 are passed through the apertures 50 and 62 so as to lock the given framing member 20a to 20d within the respective bracket sleeve member 72. Once in place, a pin securing device using cable 132, such as the one described in connection with the coupler, can be used to secure each bracket locking pin 130 in place. As will be easily understood by one skilled in the art, a different number of pair of apertures 62 could be provided along the side walls that need not be exactly parallel. Moreover the bracket 34 could be affixed to the framing members 20a to 20 using a different arrangement and locking mechanism without departing from the scope of the present invention.

With regard to the embodiment where the framing member 20a to 20d are permanently coupled to each other, as illustrated in FIGS. 1 to 3, the bracket 34 is provided with a pair of bracket sleeve members 72 each oriented horizontally to engage one of the two of the framing members meeting at one of the corners of the polygonal arrangement.

As mentioned above, in one of the possible embodiment illustrated on FIGS. 4 to 8, the framing members 20a to 20d are coupled in an overlapping arrangement. In order to enable the bracket 34 to be mounted at any of the four corners of the base support 10, two bracket sleeve members 72 are preferably provided welded back-to-back in parallel on each side of the bracket 34. As seen most clearly in FIG. 6, the leftmost framing member 20c is received within the downward-facing U-shaped bracket sleeve member 72. The second, upward-facing bracket sleeve member 72 is positioned thereabove and remains empty. In contrast, it is the upward-facing bracket sleeve member 72 which receives the framing member 20a, while the downward-facing bracket sleeve member 72 remains empty. Were the bracket 34 to be installed at the junction of the framing members 20a and 20d, then the reverse would be true. In this manner, the bracket 34 can receive a framing member 20a to 20d from either above or below and can be mounted at any of the four corners 23a to 23d.

Returning now to FIGS. 1 to 3, a removably securable security barrier 80 can be combined to the base support 10 in order to provide a fall guarding system. It should be noted that even though, the security barrier is shown here only in combination with the first embodiment, where the framing members 20a to 20d are permanently joined together, a security barrier 80 could be secured to a base support 10 according to any one of the described embodiments. The security barrier 80 comprises a plurality of sections extending substantially vertically over the framing members 20a to 20d at a height 81 that is sufficient to prevent workers or individuals that may circulate around the opening 12 to inadvertently fall into it and in order to comply with the various standards of the industry. In order to improve the versatility of the present fall guarding system, the height 81 will preferably be adjustable such that workers will be able to adjust the height 81 of the barrier 80 to comply with the standards in force in their respective jurisdiction.

One or more sections of the security barrier 80 can be hingedly attached together by a hinge 82, in order to allow one or more access doors 84 to move between a closed position 86 and an open position 88, thereby providing access points to the inside parameter of the barrier 80. A door locking mechanism 90 is provided at an extremity of each access door 84 to maintain the door in place when in the closed position 86.

Moreover, the security barrier 80 preferably is configured such that a section 92 located proximate to the hoisting apparatus 14, is biased to run in front of the mast 16 of the hoisting apparatus 14, thereby blocking access to the inside perimeter of the barrier, without impacting on the operation of the hoisting apparatus 14. Alternatively, the security barrier 80 could run behind the hoisting apparatus 14, resulting in the hoisting apparatus 14 being located in the inside perimeter of the security barrier 80, without departing from the scope of the present invention.

In order to facilitate displacement and transport of the base support 14 and security barrier 80, the security barrier 80 is preferably secured to the base support 14 in a removable manner. The attachment of the security barrier 80 to the base support is preferably similar to that of the bracket 34 and couplers 26, i.e at least one barrier sleeve member 85 comprised on the security barrier 80 receiving a framing member therein. In the illustrated embodiment, each leg of the security barrier ends with a section of U-shaped stock forming a barrier sleeve member 85 for receiving a corresponding framing member 20a to 20d therein. As it is the case for the couplers 26 and the bracket 34, each barrier sleeve member 85 comprises first and second parallel side walls 85a and 85b which are configured to receive one of the framing members 20a to 20d therebetween. The first and second parallel side walls 85a and 85b are provided with two pair of apertures 87 which can be aligned with two of the apertures 50 along each framing member 20a to 20d. Preferably, two barrier locking pin pins 230 are passed through the apertures 50 and 87 so as to lock the given framing member 20a to 20d within the respective barrier sleeve member of the leg 83 of the security barrier 80. Once in place, a pin securing device using cable 232, such as the one described in connection with the coupler 26, can be used to secure each barrier locking pin 230 in place. Once again, as will be easily understood by one skilled in the art, a different number of pair of apertures 87 could be provided along the side walls that need not be exactly parallel. Moreover the security barrier 80 could be affixed to the framing members 20a to 20 using a different arrangement and locking mechanism without departing from the scope of the present invention.

Referring now to FIGS. 1, 3 and 8, the base support 10 preferably includes a plurality of feet 40 attached to each framing member 20a to 20d. Each foot 40 extends below the members 20a to 20d, thereby lifting the rest of the base support 10 off the ground by a height 42. The feet 40, which engage the ground or other surface beneath the base support 10, are preferably adjustable so as to further adapt the base support 10 to the surface upon which it is installed.

In one embodiment, a vertically-extending threaded hole is provided through each framing member 28 and the feet 40 are provided with a correspondingly threaded shaft 74, which is thereby translatable vertically with respect to the framing member 20a to 20d. The shaft 74 terminates in an engaging portion 76 which contacts the surface below and, once adjusted, can be locked in place by a lock nut or the like. The adjustable feet 40 can thereby be used to level the base support 10 prior to use.

The feet 40 as shown in the illustrated embodiments may be omitted in cases where a levelling of the framing members is not necessary, or replaced by longer stem supports, for use in softer ground. In other embodiments, clamps (not shown) may be provided under the framing members instead of feet 40, so that the base support 10 may be affixed to an elevated structure instead of the ground.

The feet 40 can be provided at each corners 23a to 23d (as shown in FIG. 1), at the extremity of each framing member 20a to 20d (as shown in FIG. 8) or at other appropriate positions around the polygonal arrangement formed by the framing members.

For an application such as a manhole, the height 42 can for example be variable between a maximum of 19.30 centimetres (or approximately 7.6 inches) and a minimum of 6.60 centimetres (or approximately 2.6 inches).

As can better be seen on FIGS. 1 and 2, a ladder support 100 can also be mounted on the base support to offer a secure support for a ladder that can be used to go down the opening 12. In the illustrated embodiment, the ladder support also includes a section of U-shaped stock forming support sleeve member 102 for receiving a corresponding framing member 20a to 20d therein. Similarly to the couplers 26, bracket 34, and security barrier 80, the channel of the U-shaped stock 102 is provided with two pair of apertures 104 which can be aligned with two of the apertures 50 along each framing member 20a to 20d. Preferably, two pins 430 are passed through the apertures 50 and 104 so as to lock the given framing member 20a to 20d within the respective channel of the barrier sleeve member 102. Once more as will be easily understood by one skilled in the art, the ladder support 100 could be affixed to the framing members 20a to 20 using a different arrangement and locking mechanism without departing from the scope of the present invention.

A base support such as the one described in the above preferred embodiments could also be used as part of a hoisting assembly further comprising a mast 16 and a jib crane 18.

As being now better appreciated, the present invention is an improvement and presents several advantages over other related systems known in the prior art. The base support according to the present invention provides a stable structure on which to mount a hoisting apparatus, security barrier or other components. While conventional base supports may be deployable and/or dismountable, they are typically designed to fit a specific opening of specific dimensions and cannot be easily combined with security barrier 80. In contrast, it will be appreciated that a base support in accordance with some embodiments of the present invention is particularly advantageous in that, it can easily be combined with such a security barrier 80, and when comprising the plurality of couplers 26 for coupling the framing members 20a to 20d together, it can be adapted to a wide variety of holes and/or openings, in a variety of situations and accommodate a variety of other constraints.

Of course, numerous modifications could be made to the above-described embodiment without departing from the scope of the invention, as apparent to a person skilled in the art.

1. A base support for mounting a hoisting apparatus over an opening, the base support comprising:
a plurality of elongated framing members, the framing members being coupled to each other in a closed polygonal arrangement sized and shaped to surround the opening, the polygonal arrangement having a plurality of corners where two of the framing members meet; and
a hoisting apparatus bracket securable to at least one of the framing members and having a hoisting apparatus mounting assembly for mounting the hoisting apparatus thereto.

2. The base support of claim 1, wherein each of the framing members is provided with a plurality of apertures extending transversally therein.

3. The base support of claim 2, wherein the hoisting apparatus bracket comprises:
at least one bracket sleeve member adapted to engage one of the framing member, each bracket sleeve member comprising first and second parallel side walls adapted to extend on either sides of the corresponding framing member; and
at least one bracket locking mechanism, each bracket locking mechanism being associated with one of the bracket sleeve members for securing said one of the bracket sleeve members to the corresponding framing member.

4. The base support according to claim 3, wherein each bracket locking mechanism comprises:
at least one pair of apertures extending in transversal alignment through the first and second side walls of the corresponding bracket sleeve member;
at least one bracket locking pin, each bracket locking pin being associated with a corresponding pair of apertures in the bracket sleeve member and insertable in the aperture in the first wall, one of the apertures of the corresponding framing member and the aperture in the second wall, successively; and
at least one pin securing device, each pin securing device being associated with a corresponding one of the bracket locking pin for securing the same in position through said apertures.

5. The base support of claim 4, wherein the at least one pin securing device comprises a cable attachable to respective extremities of the corresponding one of the bracket locking pin.

6. The base support according to claim 3, wherein each bracket sleeve member comprises back-to-back U-shaped sleeves each sized and shaped to received said one of the framing members therein, and each having a corresponding pair of first and second side walls.

7. The base support according to claim 3, wherein the hoisting apparatus bracket comprises a pair of said bracket sleeve members each oriented to engage one of the two of the framing members meeting at one of the corners of said polygonal arrangement.

8. The base support according to claim 7, wherein the hoisting apparatus mounting assembly comprises a linking structure connecting the bracket sleeve members of said pair and a mast sleeve affixed to said linking structure.

9. The base support according to claim 1, wherein the two of the framing members meeting in a respective one of the corners are permanently joined to each other thereat.

10. The base support according to claim 2, further comprising a plurality of couplers, each of the couplers being associated with a respective one of the corners for coupling the two of the framing members meeting thereat.

11. The base support of claim 10, wherein each of the couplers comprises:
first and second coupler sleeve members adapted to engage one of the framing member, the first and second coupler sleeve members comprising first and second parallel side walls adapted to extend on either sides of the corresponding framing member; and
first and second coupler locking mechanisms associated with the first and second coupler sleeve members for securing said first and second coupler sleeve members to the corresponding framing member at one of a plurality of locking positions along a length of the corresponding framing member.

12. The base support of claim 11, wherein the first and second coupler sleeve member are affixed together back-to-back at a right angle thereby resulting in the polygonal arrangement being a rectangle.

13. The base support according to claim 11, wherein the first and second coupler locking mechanisms comprise:
at least one pair of apertures extending in transversal alignment through the first and second side walls of the corresponding coupler sleeve member;
at least one coupler locking pin, each coupler locking pin being associated with a corresponding pair of apertures in the coupler sleeve member and insertable in the aperture in the first wall, one of the apertures of the corresponding framing member and the aperture in the second wall, successively; and
at least one pin securing device, each pin securing device being associated with a corresponding one of the coupler locking pin for securing the same in position through said apertures.

14. The base support of claim 13, wherein the at least one pin securing device comprises a cable attachable to respective extremities of the corresponding one of the coupler locking pin.

15. The base support of claim 1 in combination with a security barrier, wherein the security barrier is removably securable to the base support.

16. The combination of claim 15, wherein the security barrier comprises:
at least one barrier sleeve member adapted to engage one of the framing member, each barrier sleeve member comprising first and second parallel side walls adapted to extend on either sides of the corresponding framing member; and
at least one barrier locking mechanism, each barrier locking mechanism being associated with one of the barrier sleeve members for securing said one of the barrier sleeve members to the corresponding framing member.

17. The combination of claim 16, wherein each barrier locking mechanism comprises:
at least one pair of apertures extending in transversal alignment through the first and second side walls of the corresponding barrier sleeve member;
at least one barrier locking pin, each barrier locking pin being associated with a corresponding pair of apertures in the barrier sleeve member and insertable in the aperture in the first wall, one of the apertures of the corresponding framing member and the aperture in the second wall, successively; and
at least one pin securing device, each pin securing device being associated with a corresponding one of the barrier locking pin for securing the same in position through said apertures.

18. The combination of claim 17, wherein the at least one pin securing device comprises a cable attachable to respective extremities of the corresponding one of the barrier locking pin.

19. The base support of claim 1, further comprising a plurality of adjustable support feet, the adjustable support feet projecting below the framing members thereby engaging the surface located underneath the base support around said opening.

20. A hoisting assembly comprising:
a mast;
a jib crane mounted to the mast and extending over an opening; and
a base support comprising:
a plurality of elongated framing members, the framing members being coupled to each other in a closed polygonal arrangement sized and shaped to surround the opening, the polygonal arrangement having a plurality of corners where two of the framing members meet; and
a bracket securable to at least one of the framing members and having a mast mounting assembly for mounting the mast thereto.
